(19) United States
(12) Patent Application Publication
(10) Pub. No.: US 2015/0304238 A1
(43) Pub. Date: Oct. 22, 2015

(54) Bandwidth Management in Local Premise Networks

(71) Applicant: Invent.ly LLC, Woodside, CA (US)

(72) Inventor: Stephen J. Brown, Woodside, CA (US)

(73) Assignee: Invent.ly LLC, Woodside, CA (US)

(21) Appl. No.: 14/255,473

(22) Filed: Apr. 17, 2014

(51) Int. Cl. H04L 12/911; H04L 12/801

(52) U.S. Cl. CPC H04L 47/783; H04L 47/13; H04L 47/822

(57) ABSTRACT

A router has a processor, a data repository, a primary port to Internet connection on a primary path, wired connection or wireless coupling to individual ones of a plurality of bandwidth-using devices forming a local premise network, the router and the bandwidth-using devices sharing bandwidth on the primary port, software executing on the processor from a non-transitory medium, execution of the software providing a mechanism for configuration, applying a priority level to individual ones of the bandwidth-using devices in the local premise network, monitoring bandwidth available on the primary path on a periodic or continuous basis, apportioning bandwidth share among the devices in the local premise according to the priority level of each device and the current bandwidth available, and managing receipt and transmission of packets to and from individual ones of the devices according to the bandwidth share apportioned.

### BACKGROUND OF THE INVENTION

1. Field of the Invention

The present invention is in the field of smart premise technology and pertains particularly to methods and apparatus for managing bandwidth for smart networks and appliances, including managing bandwidth options among multiple bandwidth-consuming appliances or devices within the networks.

2. Discussion of the State of the Art

With the advent of the Internet and of relatively seamless communications capabilities that now exist between sub-networks of the Internet, including communications carrier networks, service providers are marketing smart technologies that bundle different types of digital services that may be delivered through a single premise network router or hub. The fact that a single router or hub may efficiently handle all of the communications and media routing to appropriate end appliances local to the router helps to reduce or otherwise streamline the complexity of many smart premise networks (SPN).

There is, however, a drawback in bundling all services to use one conventional network router for communication. The local premise network becomes vulnerable to bandwidth fluctuation which can result in idling of digital services running alone or in tandem with other services. With bandwidth availability being unstable or otherwise not consistent, it has occurred to the inventor that clients using smart technologies, including bundled communications and media services, would benefit if access to bandwidth could be prioritized and managed.

Therefore, what is clearly needed is a smart premise networking router system that includes functionality to monitor bandwidth availability, to prioritize individual users on the local network, and to throttle bandwidth accordingly at need.

### BRIEF SUMMARY OF THE INVENTION

In an embodiment of the invention a router is provided, comprising a processor, a data repository, a primary port to Internet connection on a primary path, wired connection or wireless coupling to individual ones of a plurality of bandwidth-using devices forming a local premise network, the router and the bandwidth-using devices sharing bandwidth on the primary port, and software executing on the processor from a non-transitory medium. Execution of the software provides a mechanism for configuration, applying a priority level to individual ones of the bandwidth-using devices in the local premise network, monitoring bandwidth available on the primary path on a periodic or continuous basis, apportioning bandwidth share among the devices in the local premise according to the priority level of each device and the current bandwidth available, and managing receipt and transmission of packets to and from individual ones of the devices according to the bandwidth share apportioned.

In one embodiment the primary path is one of a telephone or cable connection. Also in one embodiment in configuration a priority is assigned to users of devices, and device priority is determined for each device by device priority and user priority. Also in one embodiment in configuration a priority is assigned to each use of each device, and device priority is determined for each device by device priority, user priority and use priority. Still in one embodiment the router further comprises a backup port to Internet connection on a secondary path, and the router is enabled to switch to the secondary path upon the bandwidth determined in the monitoring step being at or below a preset threshold, or according to a specific rule.

In one embodiment the backup path is a cellular network connection. Also in one embodiment the configuration mechanism enables entry of rules to a rule set, the rule set consulted in the step of apportioning bandwidth for devices. Also in one embodiment the software further comprises a learning algorithm and process, and wherein the learning algorithm augments the rule set to aid in apportioning bandwidth to individual ones of the devices in the local network. In another embodiment the router receives data and information regarding at least the primary path from an Internet-connected resource, and the data and information augment the rule set to aid in apportioning bandwidth to individual ones of the devices in the local network. Also in one embodiment individual premise networks are registered to receive the data and information.

In another aspect of the invention a method is provided, comprising steps of (a) applying a priority level to individual ones of bandwidth-using devices in a local premise network, by a router having a processor, a data repository, a primary port to Internet connection on a primary path, and wired connection or wireless coupling to individual ones of the bandwidth-using devices; (b) monitoring bandwidth available on the primary path on a periodic or continuous basis; (c) apportioning bandwidth share among the devices in the local premise according to the priority level of each device and the current bandwidth available; and (d) managing receipt and transmission of packets to and from individual ones of the devices according to the bandwidth share apportioned.

In one embodiment of the method the primary path is one of a telephone or cable connection. Also in one embodiment in configuration a priority is assigned to users of devices, and device priority is determined for each device by device priority and user priority. Also in one embodiment in configuration a priority is assigned to each use of each device, and device priority is determined for each device by device priority, user priority and use priority. Still in one embodiment the router further comprises a backup port to Internet connection on a secondary path, and the router is enabled to switch to the secondary path upon the bandwidth determined in the monitoring step being at or below a preset threshold, or according to a specific rule.

In one embodiment the backup path is a cellular network connection. Also in one embodiment the configuration mechanism enables entry of rules to a rule set, the rule set consulted in the step of apportioning bandwidth for devices. Also in one embodiment the software further comprises a learning algorithm and process, and wherein the learning algorithm augments the rule set to aid in apportioning bandwidth to individual ones of the devices in the local network. In one embodiment the router receives data and information regarding at least the primary path from an Internet-connected resource, and the data and information augment the rule set to aid in apportioning bandwidth to individual ones of the devices in the local network. And in one embodiment individual premise networks are registered to receive the data and information.

### BRIEF DESCRIPTION OF THE SEVERAL VIEWS OF THE DRAWINGS

FIG. 1 is an architecture diagram depicting arrangement of elements in one embodiment of the invention.

FIG. 2 is a block diagram depicting detail of elements in a router in one embodiment of the invention.

FIG. 3 is a block diagram depicting multiple connected bandwidth consumers to a smart router.

FIG. 4 is a diagram of a matrix in determining priority levels for users and devices in an embodiment of the invention.

FIG. 5 is a flow diagram depicting a process in one embodiment of the invention.

### DETAILED DESCRIPTION OF THE INVENTION

In various embodiments described in enabling detail herein, the inventor provides a unique system for managing bandwidth for multiple bandwidth-sharing appliances connected to a smart network in a home or business (premises). The present invention is described using the following examples, which may describe more than one relevant embodiment falling within the scope of the invention.

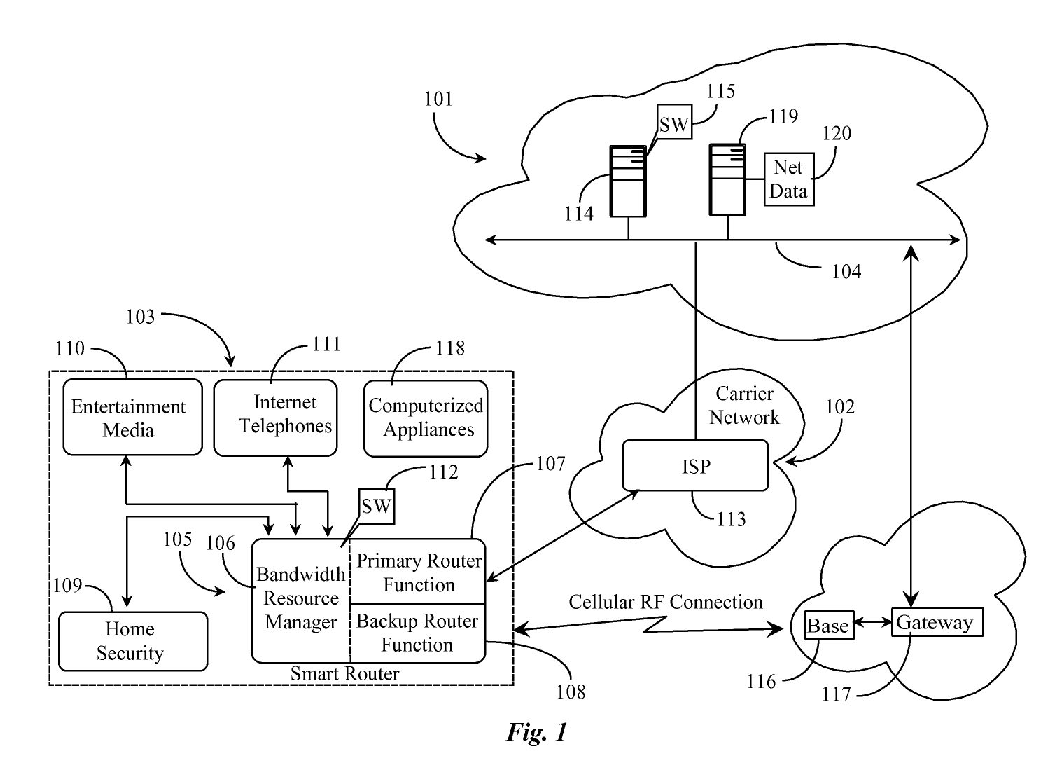

FIG. 1 is an architecture diagram depicting arrangement of elements in one embodiment of the invention. The system as shown includes elements in the Internet network. The Internet network 101 is further characterized by a network backbone 104 that represents all of the equipment, lines and access points that make up the Internet as a whole including any connected sub-networks. Therefore there are no geographic limitations to the practice of the invention. Internet 104 may be a corporate WAN or a combination of wide area networks without departing from the spirit and scope of the invention. The inventor illustrates the Internet as a preferred network because of wide public accessibility characteristics.

The unique system comprises a Smart Router 105 having a Bandwidth Resource Manager 106, a primary router function 107 and a backup router function 108. Among the different sorts of Internet access known, the primary router function will be in typical cases either Digital Subscriber Line (DSL) through a telephone carrier, a cable modem, or some sort of optical network connection to the Internet. Other forms, which may be more expensive and may provide less bandwidth, or both, will be used for backup in case of loss of, or severe restriction of the primary router path.

In FIG. 1 a carrier network 102 having an Internet Service Provider (ISP) 113 is shown to illustrate the primary router function. In this example a cellular path is illustrated as the backup path, connecting to a base station 116 by RADIO FREQUENCY (RF), thence through a gateway 117 to the Internet. The backup might in some instances also be a satellite service.

It should be noted that the provision of a primary and a backup path for access to the Internet is not a limitation in all embodiments of the present invention. In some cases there may be only one path, and that may be a relatively low bandwidth path, but this does not preclude bandwidth monitoring and management for individual ones of access points in a local network.

The terminology “smart-home” as is often used with smart networks at local residences should not be taken to limit the invention to residences, and premise is used in this specification as a more general term to indicate that the systems and functions described in various embodiments may service homes, businesses, and networks in other organizations without departing from the spirit and scope of the present invention.

Smart router 105 is illustrated in this example as providing access to the Internet for a Smart Premise Network 103, which includes Internet telephone service 111 at various points in network 103, entertainment and media systems 110 that may include such as television, gaming systems, and the like, home security apparatus 109, and various and sundry computers, such as laptops, iPads, and other computerized appliances.

In this environment router function 107 handles all data traffic between bandwidth-using elements of local network 103 and resources in the Internet. It is self-evident that gathering all of the appliance and systems on a single network that communicates through a single router minimizes expense and complexity of managing the local network. However, it is also true that the one router and network provider creates an increased vulnerability for all of the networked appliances and systems to network bandwidth availability issues that might arise. It is also true, that in the estimation of an owner or manager of network 103, not all of the bandwidth-using elements in network 103 are equally deserving of maximum bandwidth, should bandwidth become scarce. In a situation where the supply is copious, and the demand of network 103 is far less than the supply, all elements in 103 may be afforded unfettered access. If, however, demand should increase beyond supply, then a means of prioritizing and managing bandwidth among competing interests is highly desirable.

Returning to FIG. 1, a server 114 is provided in one embodiment in the Internet network. Server 114 includes a processor, at least one data repository, and software (SW) 115 executing from a non-transitory medium on the processor, the SW comprising all instructions required to function as a Web server. In one embodiment, a Web site is provided by SW 115 to owners or managers of smart premise networks so that they may register for bandwidth optimization notifications. Server 114 may be hosted by the provider of network services and the smart router. In one embodiment SPN's may be managed remotely through SW 115.

Server 114 has access on the Internet, and by executing SW 115 to a server 119 that in one embodiment monitors Internet connection patterns and fluctuations, and information from various bandwidth providers, such as telephone interchanges and cable providers. Such information may be recorded and processed to determine predictive patterns for bandwidth availability by geographic region, and may be used by server 114 to provide updates to registered smart premise networks as to expected variations in bandwidth availability in the particular regions where the smart premise networks may operate. Such warnings may be used by bandwidth resource manager 106 in some circumstances to aid in bandwidth allocation within smart premise 103, or to cause a switch to a backup router path, for example.

There are many known causes for bandwidth fluctuation for a smart premise network. Consider in the case that the primary router function 107 is a DSL or a cable connection, there may be several users in one neighborhood all sharing a connection of a single maximum bandwidth. If one user A has a requirement for a certain total bandwidth, and is accessing this service at 3:00 AM, that user may have no problem. But at another time two neighbors may be watching movies, and the bandwidth available to user A will be curtailed. Other causes may be problems in telephone lines over which a DSL connection may be carried. Temperature fluctuations in equipment may cause fluctuations in bandwidth capability. There are many different conditions which may affect available bandwidth for one smart premise network.

To provide for management of bandwidth within smart premise network 103, smart router 105 includes bandwidth resource manager 106. Bandwidth resource manager 106 may share a CPU, which may be a microprocessor, and operational memory (not illustrated here) with router functions 107 and 108. Bandwidth resource manager 106 executes coded instructions (SW 112) from a non-transitory medium.

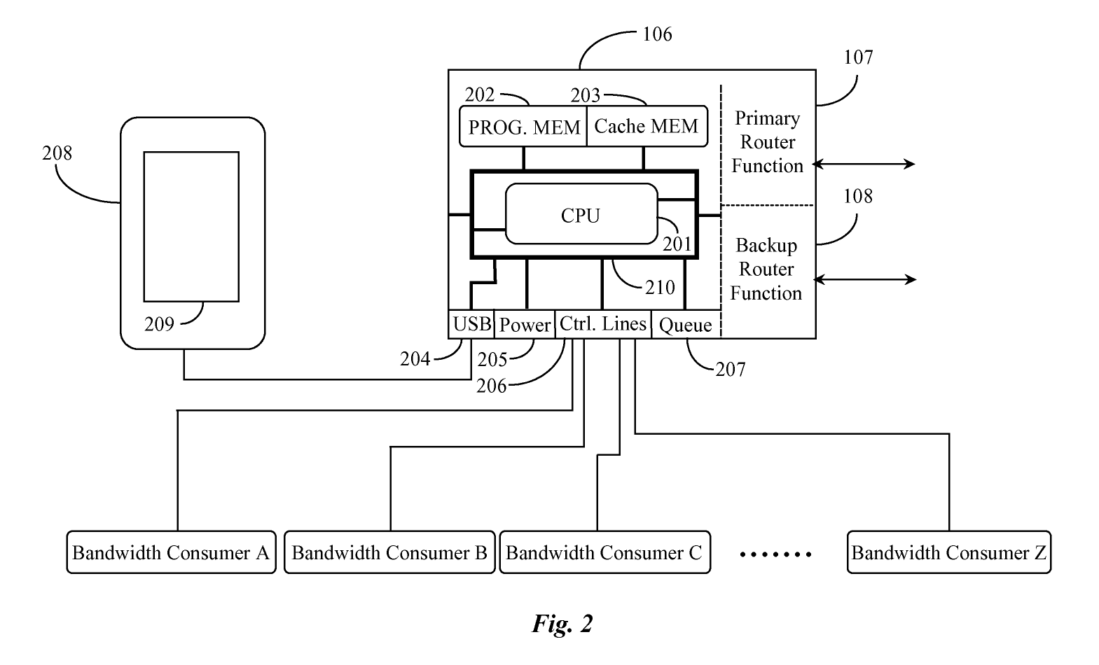

FIG. 2 is a block diagram depicting a smart premise network with a router having bandwidth resource manager components depicted in more detail in one embodiment of the invention. Bandwidth resource manager 106 includes a central processing unit CPU 201, which may in some embodiments be a microprocessor. Processor 201 communicates with other components through a BUS structure 210 illustrated logically herein and for discussion purposes.

Microprocessor 201 has access to a programmable (PROG) memory (MEM) 202. MEM 202 contains all of the coded instruction (SW 112) required to provide bandwidth management and ordered prioritization relative to bandwidth consumers A-Z that may be active in a smart premise network such as network 103 of FIG. 2. MEM 202 may include a non-volatile memory such as a flash memory or a read-only memory (ROM) including variations thereof. MEM 202 may also include a volatile memory portion such as a random access memory (RAM) or any variation thereof.

In a local premise network, some of bandwidth consumers A-Z may be smart devices having an IP address and capable of wireless (or wired) network connection, and for these consumers bandwidth management may be done wirelessly from smart router 105 sending data and commands. For consumers that do not communicate wirelessly, control lines 206 may be provided to control bandwidth settings associated with those power consumers. In one embodiment, bandwidth settings connected to the device modem may be manipulated by SW 112 over a control line or via wireless communication to lower the maximum amount of bandwidth the device receives.

Control lines 206 may also be leveraged to control the on/off state of that consumer's network router connection and therefore, access to remote communication on the Internet or on a broader connected network. In one embodiment access to the router channel for a particular bandwidth consumer is performed on the smart router in both wired and wireless embodiments.

Processor 201 has access to a cache memory (MEM) 203. MEM 203 contains temporary data including activity logs, communication logs, temporary settings, etc. Cache MEM 203 may be a high speed RAM or other MEM type suitable for high speed caching and access to cached data. Bandwidth resource manager 106 includes a power interface 205 in this example. An internal battery may be used in the event of loss of another power source. In one embodiment bandwidth resource manager 106 includes a switch circuitry that automatically switches to internal battery power if no other power source is available due to a power outage.

In one embodiment switch circuitry (not illustrated) is provided to enable processor 201 to switch over from one source of power to another based on notification of one or more conditions. It is important to note herein that processor 201 may affect switch over from one power source to another based on an actual event that occurs without warning such as unpredictable loss of a source of power currently being drawn by way of act of nature or other accident. In this embodiment processor 201 may also switch over from one power source to another based on receipt of a notification containing information that causes prioritization of power source selection. In case of an actual loss of power event that occurs without prediction, the switchover is hard-wired and occurs by default.

In one embodiment smart router 105 may include a universal serial bus (USB) port 204. USB port 204 may be used to communicate via USB cable to a peripheral computing appliance 208 such as a tablet device with a display 209 and input capability (touch screen). In one embodiment USB port 204 is a wireless USB port or another type of port supporting another type of wireless communications technology such as Bluetooth, infrared, radio frequency (RF), etc.

In one embodiment a premise network owner or service technician may connect appliance 208 to smart router 105 via USB port 204 to provide new component prioritization instruction, modify existing priority instruction, or to troubleshoot the system. Processor 201 may recognize appliance 208 when plugged into port 204 and powered on, and may serve an electronic user interface (UI) stored in PROG MEM 202 for use in interaction with the manageable parts of the system. In another embodiment, a user interface for configuring bandwidth resource manager 106 may be accessible remotely through router function 107 by navigating on the network using a browser interface to the IP address of Router 105.

Smart router 105 includes a queue 207 in one embodiment for queuing messages including control messages from smart premise network administrators, and alerts or notifications from a central server analogous to 116 of FIG. 1. Queue 207 may be shared by bandwidth resource manager 106 and router functions 107 and 108. There may also be separate dedicated queues for each component (router function and bandwidth resource manager). Queue 207 may be a first-in-first-out (FIFO) queue or a prioritized queue wherein certain alerts or notifications take priority over other routine messages. Such alerts or notifications may be those that inform bandwidth resource manager 106 of a predicted bandwidth availability issue. Bandwidth alert or notifications may include parameters about the predicted event. The alert or notification may include an event title or an event category such as “bandwidth availability alert”. The alert or notification may include the exact nature of the alert. For example, intermittent bandwidth outages predicted for today between 12:00 PM and 5:00 PM. The alert or notification may include a time window or a time to live (TTL) for the alert to be in effect.

Alerts or notifications may be flagged in queue 207 according to one or more levels of priority. An alert table or scheme may be provided that may trigger one or more preset bandwidth management states to be initiated by bandwidth resource manager 106. That is to say that the nature of an alert or notification may cause microprocessor 301 of bandwidth resource manager 106 to initiate a preset bandwidth management state according to priority settings previously input into the bandwidth resource manager by an administrator of the smart premise network.

As an example, assume that bandwidth consumer A is a media entertainment system and service such as an online interactive gaming system, and that bandwidth consumer B is an office network connecting an office worker to the Internet. If an alert is received at 9:00 AM warning of a bandwidth scarcity with possible interruptions between 12:00 PM and 5:00 PM on the same date, bandwidth resource manager 106 may equate the alert to a preset bandwidth management alert level that has been associated or linked to a preset bandwidth management configuration. Bandwidth resource manager 106 may initiate a bandwidth shutdown for Internet gaming system A to begin at 12:00 PM to remain in effect until 5:00 PM, leaving available bandwidth to consumer B. The bandwidth shutdown may be accomplished via disconnecting the system from the router channel. Other alternatives may include switching the bandwidth settings on the system to lower bandwidth operation or actually shutting the system down for the alert TTL.

In one embodiment, bandwidth alerts come into bandwidth resource manager 106 via the router function 107 and connection to the Internet network illustrated herein by a double arrow emanating from router function 107. Such alerts have been generated on a central server like server 116 of FIG. 1 from intelligence from various sources described further above with respect to FIG. 1. Alerts having a same geo-tag indicative of the geographic area covered in an alert are sent to smart premise networks located in those geographic areas. In one embodiment, after the time window associated with an alert has passed, bandwidth resource manager (BRM) 106 may reset bandwidth consumers A-Z back to their pre-alert priority states.

In this example bandwidth resource manager 106 is hosted on smart router 105 along with routing components 107 and 108. However, in an alternative embodiment the functionality of bandwidth resource manager 106 may be implemented on a completely separate hardware such as a dedicated smart premise network processor with a router connection without departing from the spirit and scope of the present invention. In one embodiment a smart premise network may receive one or more alerts and may initiate a bandwidth management priority state affecting one or more bandwidth consumers A-Z when no administrator is available or at the location of the network. In such instances bandwidth resource manager 106 may be capable of generating short messages to inform a remote administrator of the activity through the onboard routing function. The administrator may receive such activity notifications in email, on social media pages, on a mobile device, or by automated phone call. In one embodiment, an administrator may intervene and override alert-triggered bandwidth priority settings on site or from a remote location using a Web-connected communication appliance having a browser, a display and a means of data input.

In one embodiment the schedule of the smart premise network administrator is taken into account when creating priority settings for the bandwidth consuming appliances and systems. For example, when there will be no one on site, BRM 106 may maintain a lower bandwidth management profile for one or more bandwidth consumers.

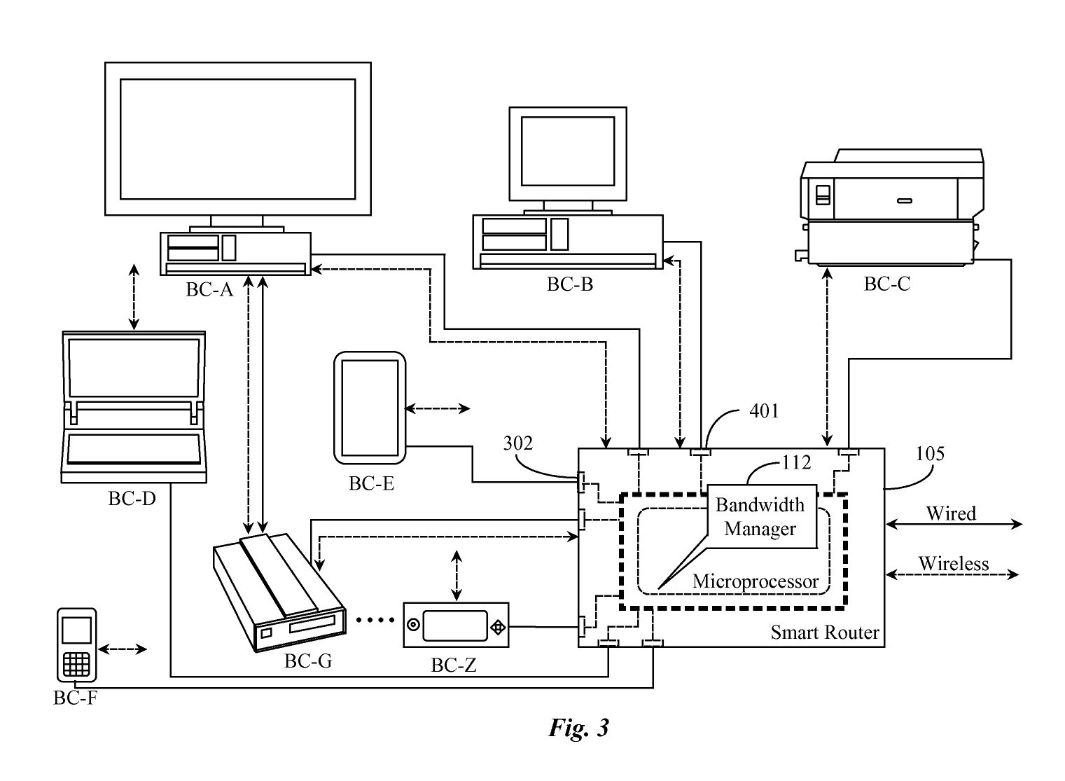

FIG. 3 is a block diagram depicting multiple bandwidth consumers connected to a smart router 105. The diagram represents a smart premise network analogous to network 103 of FIG. 1. Smart router 105 may have wired access and wireless access to the external network such as the Internet network. In this example several bandwidth consumers (BC) are depicted connected to smart router 105 for reference. BC-A is an entertainment media system. BC-A has connection to smart router 105 via one of several connection ports 301. BC-A may also communicate wirelessly through smart router 105 as indicated herein by a broken double arrow adjacent to the wire line. BC-B is a desktop work computer station. BC-B has a wired connection to a port 301 on smart router 105 and an alternative wireless connection through router 105. BC-C is a network printer. BC-C has a wired connection to smart router 105 and a wireless connection to the router.

Some networked devices may have wireless connection for communication and Internet access through a G(x) carrier network and may, in some cases, be able to access the Internet and reserve sufficient shared bandwidth at a time when smart router 105 is not able to reserve sufficient bandwidth for operation. BC-D is a laptop computer that may connect by wire to router 105 or wirelessly to the external Internet without requiring connection to router 105. Likewise, BC-E is a notepad touch screen device. BC-E may also be connected by wire to router 105 and may also have network capability independent of router 105.

BC-F represents a cell phone with wireless network capability independent of router 105. BC-F may connect to outer 104 by wire to one of ports 301 as previously described. Other devices include BC-G, which is a gaming box in this example. BC-G may connect to router 105 by wire or wireless connection. BC-G may also communicate with BC-A for visual display and sound system for playing Internet-based Games. BC-Z represents a hand-held mobile gaming device. BC-Z has wireless access through a private carrier to the Internet independent of router 105. BC-Z may connect to router 105 and access the network through the router.

The bandwidth manager through execution of SW 112 may monitor and manage or regulate how bandwidth is reserved by clients of the router. In one example, BC-G is reserved bandwidth of sufficient speed and quality for gaming interaction. In a same time frame as Internet gaming activity involving BC-G and BC-A, BC-B and BC-C may be connected to router 105 and reserving sufficient bandwidth for networking and transacting with other remote office nodes on other network segments. The minimum bandwidth requirements must be exceeded in order to enable simultaneous operation of all of the activities involving various competing BCs.

Smart router 105 may receive a message from a central server analogous to server 116 of FIG. 1 hosting SW 117, the SW executable from a non-transitory medium on the processor of the server. The message may be an alert notification predicting a bandwidth scarcity event that is geographically directed and predicted for a specific period of time. The time period may be characterized as having a start time and an end time characterizing the scarcity event. Such an event may take the form of one of more than one alert severity levels that instruct or otherwise trigger a decision on smart router 105 relative to bandwidth management options available to the router.

Bandwidth management options may include, but are not limited, by denying access to bandwidth to selected devices currently reserving bandwidth for communication. An alert notification having an alert level 2 of 3 levels, for example, may trigger some bandwidth management action on the router. In this case router 105 with the aid of SW 112 may, after processing the alert data, execute logic to deny access to (switch off) bandwidth to BC-G and BC-A, thus reserving the available bandwidth for BC-B and BC-C. Such prioritization may be a product of administrative input by an authorized SPN administrator.

In one embodiment of the invention, router 105 may reset a peripheral device's modem settings in order to down regulate the amount of bandwidth the device might use while connected and consuming bandwidth through the router. In one example, BC-C may receive and send data over the network relative to scanned digital documents and high resolution images, communication facsimiles, etc. Router 105 might, after processing an alert, reduce the amount of bandwidth the printer may access, leaving some activities operational but not others. This may be accomplished over a wired connection between the printer and the router.

Logic on the router (SW 112), and perhaps a thin SW client executable from a non-transitory medium on the processor of the printer, may result in a reconfiguring operation on the modem installed on the printer. Although the connection supports the maximum bandwidth speed, the channel may be narrowed to only enable the device to process under a smaller range of bandwidth. The printer then may be reconfigured on the fly to only accept a smaller amount of bandwidth sufficient for fax communication but not for high resolution image transfer and print jobs, for example.

In one embodiment certain mobile devices may be executing home health monitoring applications or security applications. In a severe bandwidth shortage affecting wireless access through a G(x) network, such devices normally depending on those networks for application communications would reserve any available bandwidth from the router according to priority settings.

A critical parameter in embodiments of this invention is bandwidth available on the primary path to the premise as a whole, and this parameter may be measured on a periodic basis by the router executing SW 112, or continuously. Bandwidth variation and outages may be recorded by date and time, and patterns may be determined to be saved and used in management protocol.

In one embodiment bandwidth fluctuation data recorded by bandwidth resource manager (BRM) 106 may be managed for each bandwidth consumer on the network according to priority settings enacted in part through administrative preferences and according to bandwidth cost modeling for each bandwidth consumer. In another variation of this aspect, the client owner of the premises (business or home) may authorize third-party access to bandwidth usage data records maintained for that SPN at a server on the Internet or in a database maintained by smart router 105.

Bandwidth resource manager 106 comprises I/O capability for a network manager or administrator, which may be a homeowner in some embodiments, to set priorities for bandwidth for individual ones of bandwidth-consuming devices in the local network. This capability may be, in one embodiment, connection to an appliance with general-purpose computer capability, enabled to provide a manager with an interactive interface. In one embodiment, remote access to bandwidth resource manager 106 is provided through a Web page hosted by the smart router, as the router is accessible by an IP Address.

It is to be understood that priority is not necessarily strictly associated with a device. Priority may also be associated with use. For example, a device that may be used to make a telephone call may have a certain priority as a device, set by a manager with access to the priority record, but priority, and therefore bandwidth, may be raised according to a telephone number that is asserted. A device with one priority, used to call 911, may be automatically bumped to higher priority and extra bandwidth made available (possibly at the expense of some other use in the premise) if need be for the call to be placed.

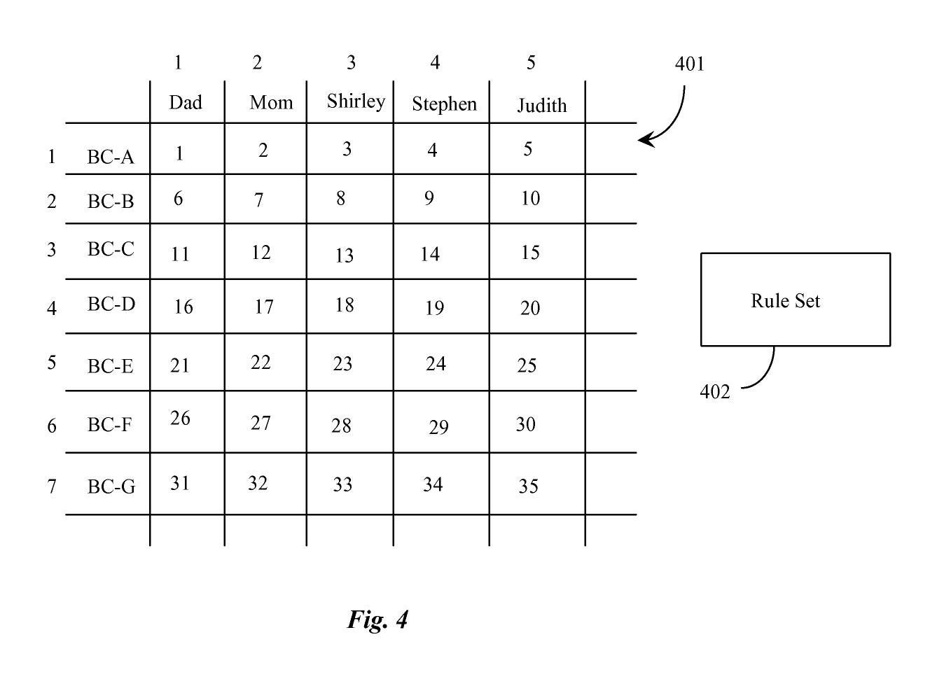

FIG. 4 is an exemplary diagram 401 of a priority matrix wherein devices BC-A through BC-Z are arranged on a vertical axis, and users of these devices are arranged on a horizontal axis. In this example the network is a home network, and the family members are Dad, Mom, Shirley (teenage daughter), Stephen (pre-teen son) and Judith (five year old daughter. If the devices BC-A through BC-G on the network are listed as device priority 1 through 7, and the family members are listed left to right as personal priority 1 through 5, then the priority at each intersection for a person using a device is the product of the two priorities. Shirley, using device BC-D then has a priority rank 18 of 35.

It is not necessary in the prioritization for the manager to draw the matrix, but simply to order the priority of the devices and users. The software can do the rest. And in addition to the granular priority that may be accomplished this way, there may also be rules in various embodiments to provide exceptions and to provide for any special conditions. For example, as mentioned above, if Mom is using device BC-F, which is a cellular telephone, the default priority is 27th. But if Mom is calling Dad, a rule may be imposed to bump that priority to 7. If Mom is using BC-F to call 911, priority may be bumped to 1, so the call cannot fail for lack of bandwidth. A set of rules 402 is indicated in FIG. 4. In configuration process there may be standard rules which may be selected and applied in the rule set, and a facility may be provided to create new rules.

In another example the bandwidth resource manager may simply regulate which bandwidth consumers on the network may have permission to access bandwidth from the router connection. That is to say that a bandwidth consumer competing on the network for outside communications may be suspended from its router access but not specifically shut down relative to its power source. For example, a child's laptop that is wirelessly connected and running on internal battery power may be suspended from communicating with the router when the priority status indicates low priority for the bandwidth consumer (laptop) and operator (child). The activity of gaming might also be a low priority in a power uncertainty state. Such a suspension may last until conditions change sufficiently to warrant reconnection of the appliance to the bandwidth channel.

Other considerations may be observed and applied relative to bandwidth management in a smart premise network without departing from the spirit and scope of the present invention, such as considering distance of connected appliances and systems from the router in a wireless embodiment. In one embodiment the router may operate with divided frequencies. The router may also include a combination of wired connections, optical connections, and wireless connections. In some cases lower-priority appliances or systems are automatically shut down, limited in their capacity to access services (router connection), or switched to operate on a narrower bandwidth capacity while active on the network.

In one embodiment an owner or manager might set priorities for different bandwidth-consuming devices and uses in the premise network as follows, in top-down order of priority:

### 1. Security Communications

Devices and uses that may be included as highest priority in this category are emergency communications, like 911 calls or a pre-defined call list, security monitoring systems like ADT™, smoke alarms like Nest™, and various health-monitoring devices. Priority may be set separately and hierarchically within this or another category as well.

### 2. Basic Communication

This applies to telephones, emails, texting, and other generally low-bandwidth uses.

### 3. High Bandwidth Communications

These may be video conferencing or large email attachments.

### 4. Work/School

Generally applications and file transfers, but may include watching videos.

### 5. Entertainment

Gaming, watching TV, watching cats in YouTube™, etc.

Once configuration is accomplished for a smart premise network in an embodiment of the invention, the bandwidth resource manager monitors available bandwidth, tracks uses on the network, and applies the priorities set and the rules established to allocate and throttle bandwidth for different devices and users.

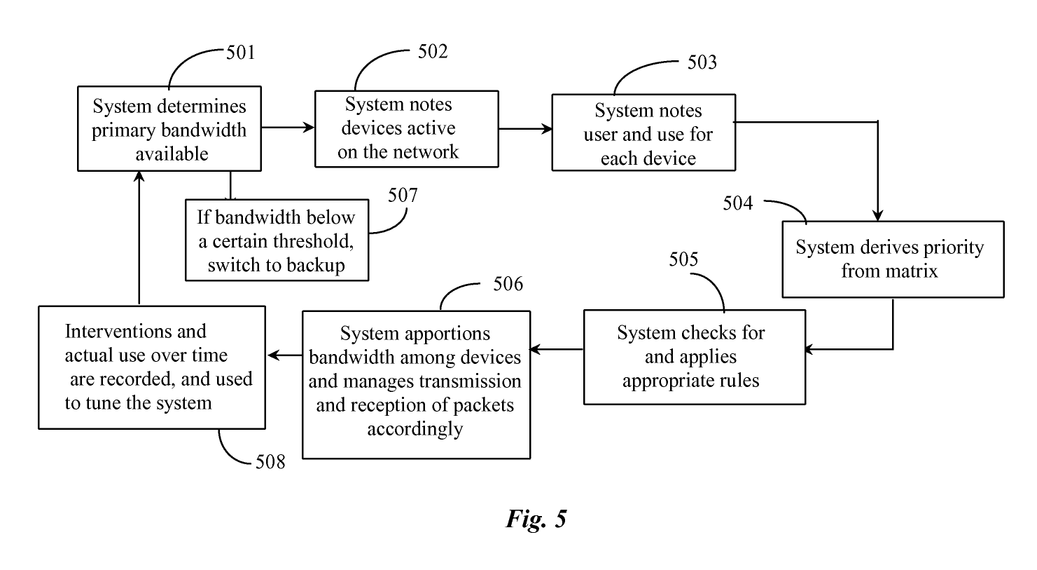

FIG. 5 is a flow diagram illustrating operation of bandwidth resource manager 106 in an embodiment of the invention. Periodically the system determines the real bandwidth available on the primary path 107 at step 501. If that bandwidth is zero or below a pre-set threshold, the system switches at step 507 to backup path 108, and continues to check the bandwidth available on the primary path. If the bandwidth on the primary path then reaches a preset threshold, the system may resort again to the primary path. The thresholds to switch in either direction are not necessarily the same.

At step 502 the system noted the devices active on the network. A device that is not powered on and capable of communicating is not included in determinations. At step 503 the system notes the user and the use for each device active. At step 504 the system derives priority from matrix 401 and modifies that priority according to use. At step 505 the system checks for and applies appropriate rules. At step 506 the system apportions bandwidth among the active devices. Then the system returns to step 501 and again determines bandwidth in the primary path, which may not have changed. The loop continues, keeping bandwidth allocation properly apportioned.

There are a number of different methods that might be used to throttle bandwidth for devices on the network. Most rely on checking packet headers, which will indicate the originating devices on the network and destinations for packets. Cache memory may be used to store packets and order packets for transmission. In a rough example, there may be two devices seeking bandwidth with one having priority over the other. The system may send, for example, two packets for one device, then one packet for the other. This may be extrapolated for a number of devices and uses to intermingle packet transmission in a manner that accomplishes the purpose.

In embodiments of the invention default priority may be set for devices and users, and determined for users of devices as described above, and rules may be set and applied. Still, one or more authorized users may command certain changes in the operation. Dad may, for example, have a very large email attachment to send, and he may intervene in the system to command higher than configured priority for a certain period.

Because of probability of intervention, and time related changes in usage and patterns, a learning algorithm is executed by the system to learn to tune bandwidth allocation beyond the default configuration. With ongoing operation changes and interventions may alter priorities that are applied. This process is indicated by step 508 in FIG. 5.

In one embodiment individual smart premise networks include a SW agent that may be part of SW 112 that, through monitoring bandwidth usage, defines usage statistics over time for all of the bandwidth consumers connected to and operating on the network and then suggests priority states for those components relative to a component hierarchy. Additional knowledge about each device may be collected and retained by smart router 105 such as, who operates the device, the activities assigned to the device, the capabilities of the device, and so on. This information may be presented upon request from the network administrator and may be useful for the administrator to re-set or confirm preset or suggested priority levels for the components. The agent may also include an interface for adding new appliances and systems (bandwidth consumers) to the network.

It should be noted that bandwidth management in embodiments of the invention is not a one-way street. However, packet transmission and reception may both be throttled and controlled in embodiments of the invention. Packets arriving at smart router 105 may be managed by bandwidth manager 103 to be delivered to different devices on the network, similarly to the way packet routing may be interleaved in outbound transmission.

It will be apparent to one with skill in the art of machine learning that the system of the present invention may continue to evolve as more data is processed and as changes occur due to infrastructure additions, alternate service providers available over the network, or other more general developments related to the entire infrastructure as a whole. It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A router, comprising:
a processor;
a data repository;
a primary port to Internet connection on a primary path;
wired connection or wireless coupling to individual ones of a plurality of bandwidth-using devices forming a local premise network, the router and the bandwidth-using devices sharing bandwidth on the primary port;
software executing on the processor from a non-transitory medium, execution of the software providing:
a mechanism for configuration, applying a priority level to individual ones of the bandwidth-using devices in the local premise network;
monitoring bandwidth available on the primary path on a periodic or continuous basis;
apportioning bandwidth share among the devices in the local premise according to the priority level of each device and the current bandwidth available; and
managing receipt and transmission of packets to and from individual ones of the devices according to the bandwidth share apportioned.

2. The router of claim 1 wherein the primary path is one of a telephone or cable connection.

3. The router of claim 1 wherein in configuration a priority is assigned to users of devices, and device priority is determined for each device by device priority and user priority.

4. The router of claim 3 wherein in configuration a priority is assigned to each use of each device, and device priority is determined for each device by device priority, user priority and use priority.

5. The router of claim 1 wherein the router further comprises a backup port to Internet connection on a secondary path, and the router is enabled to switch to the secondary path upon the bandwidth determined in the monitoring step being at or below a preset threshold, or according to a specific rule.

6. The router of claim 5 wherein the backup path is a cellular network connection.

7. The router of claim 1 wherein the configuration mechanism enables entry of rules to a rule set, the rule set consulted in the step of apportioning bandwidth for devices.

8. The router of claim 7 wherein the software further comprises a learning algorithm and process, and wherein the learning algorithm augments the rule set to aid in apportioning bandwidth to individual ones of the devices in the local network.

9. The router of claim 1 wherein the router receives data and information regarding at least the primary path from an Internet-connected resource, and the data and information augment the rule set to aid in apportioning bandwidth to individual ones of the devices in the local network.

10. The router of claim 9 wherein individual premise networks are registered to receive the data and information.

11. A method comprising steps:
(a) applying a priority level to individual ones of bandwidth-using devices in a local premise network, by a router having a processor, a data repository, a primary port to Internet connection on a primary path, and wired connection or wireless coupling to individual ones of the bandwidth-using devices;
(b) monitoring bandwidth available on the primary path on a periodic or continuous basis;
(c) apportioning bandwidth share among the devices in the local premise according to the priority level of each device and the current bandwidth available; and
(d) managing receipt and transmission of packets to and from individual ones of the devices according to the bandwidth share apportioned.

12. The method of claim 11 wherein the primary path is one of a telephone or cable connection.

13. The method of claim 11 wherein in configuration a priority is assigned to users of devices, and device priority is determined for each device by device priority and user priority.

14. The method of claim 13 wherein in configuration a priority is assigned to each use of each device, and device priority is determined for each device by device priority, user priority and use priority.

15. The method of claim 11 wherein the router further comprises a backup port to Internet connection on a secondary path, and the router is enabled to switch to the secondary path upon the bandwidth determined in the monitoring step being at or below a preset threshold, or according to a specific rule.

16. The method of claim 15 wherein the backup path is a cellular network connection.

17. The method of claim 11 wherein the configuration mechanism enables entry of rules to a rule set, the rule set consulted in the step of apportioning bandwidth for devices.

18. The method of claim 17 wherein the software further comprises a learning algorithm and process, and wherein the learning algorithm augments the rule set to aid in apportioning bandwidth to individual ones of the devices in the local network.

19. The method of claim 11 wherein the router receives data and information regarding at least the primary path from an Internet-connected resource, and the data and information augment the rule set to aid in apportioning bandwidth to individual ones of the devices in the local network.

20. The method of claim 19 wherein individual premise networks are registered to receive the data and information.
